(19) United States
(12) Patent Application Publication
(10) Pub. No.: US 2007/0003168 A1
(43) Pub. Date: Jan. 4, 2007

(54) Computer input device

(75) Inventor: Thomas C. Oliver, Windsor, CO (US)

Correspondence Address: BANNER & WITCOFF LTD.,;ATTORNEYS FOR CLIENT NOS. 003797 & 013797, 1001 G STREET , N.W., SUITE 1100, WASHINGTON, DC, 20001-4597, US

(73) Assignee: Microsoft Corporation, Richmond, WA (US)

(21) Appl. No.: 11/168,480

(22) Filed: Jun. 29, 2005

(51) Int. Cl. G06K 9/22

(52) U.S. Cl. 382/314

(57) ABSTRACT

A dual-mode input device is provided for capturing handwritten electronic ink while in a handwriting mode and for capturing scenes while in a scene capture mode. The input device includes an image capture system having a first focal length while in the handwriting mode and having a second focal length while in the scene capture mode. The input device may include a digital pen and may have a pen cap that acts as an adaptor to change the image capture system focal length between the first focal length and the second focal length. The input device may include a variable focal length mechanism for providing variable focal lengths while in the scene capture mode.

### BACKGROUND

Computer systems using graphical user interface (GUI) systems, such as Microsoft® Windows, are optimized for accepting user input from one or more discrete input devices such as a keyboard (for entering text), and a pointing device (such as a mouse) with one or more buttons for activating user selections. Stylus-based user interfaces are input devices that provide the user with printed paper-type functionality. One approach for the stylus-based user interface is to use resistive technology (common in today's PDAs). Another approach is to use active sensors in a laptop computer.

Conventional stylus-based input devices include battery-operated writing instruments that allow the user to digitally capture a handwritten note or drawing. Such a stylus-based device typically attaches to a Universal Serial Bus cradle that permits the user to upload handwritten notes or drawings to a computer system. These interfaces include an image sensor that cooperates with special digital paper or a sensor board to digitally capture what the user has written. The image capture system is specifically designed to read patterns on the digital paper or sensor board in order to interpret writing and paper position.

As such, the image capture system has a fixed focal length specific to the configuration of the stylus and the corresponding digital paper. Thus, functional uses of the input device and its image sensor are limited to the writing configurations and situations as dictated by the fixed configuration of the input device for use with its corresponding digital paper.

### SUMMARY

Aspects of the present invention relate to an input device for generating electronic ink and capturing scenes. The input device may be formed in the shape of a pen, and may or may not include an ink cartridge to facilitate movement of the input device in a familiar manner. The input device generates electronic ink using an image sensor having a first focal length and captures scenes and other images using the same image sensor, or another image sensor of the input device, having a second focal length that differs from the first focal length.

An aspect of the invention uses an input device having an imaging system in various modes according to adjustable features on the device and/or according to adaptors used with the device. In one embodiment, the input device is a digital pen and an adaptor includes a cap for the pen. When placed over the tip portion of the pen, the adaptor changes the focal length of the imaging system to permit the pen to capture scenes and other images in focus at a greater distance from the imaging system than in a writing mode.

Aspects of the invention further include methods for using input devices disclosed herein, as well as computer-readable instructions for performing the methods. The foregoing summary of aspects of the invention, as well as the following detailed description of various embodiments, is better understood when read in conjunction with the accompanying drawings, which are included by way of example, and not by way of limitation with regard to the claimed invention.

### BRIEF DESCRIPTION OF THE DRAWINGS

FIG. 1 illustrates a schematic diagram of a general-purpose digital computing environment in which certain aspects of the present invention may be implemented.

FIG. 2 illustrates an input device in accordance with at least one aspect of the present invention.

FIGS. 3A-3C show three illustrative embodiments of a camera system for use in accordance with aspects of the present invention.

FIG. 4A illustrates an embodiment of an optical design of an input device in accordance with at least one aspect of the present invention shown while the input device is in a writing mode.

FIG. 4B illustrates the imaging system of the input device of FIG. 4A.

FIG. 5A shows the input device of FIG. 4A while in a scene capture mode.

FIG. 5B illustrates the imaging system of the input device of FIG. 5A.

FIGS. 6 and 7 show illustrative hardware architectures of a system in accordance with at least one aspect of the present invention.

FIG. 8 shows an embodiment of an imaging system for use in accordance with aspects of the present invention.

FIG. 9 shows an embodiment of an input device for use in accordance with aspects of the present invention.

### DETAILED DESCRIPTION OF THE DRAWINGS

Aspects of the present invention relate to an input device that may be used in a variety of different platforms from controlling a desktop or laptop computer, writing on a whiteboard, writing on a surface such as paper, controlling a PDA or cellular phone, creating ink that may be ported among various platforms and/or capturing images. The input device includes an image sensor for use with digital writing, as well as for use with capturing graphic images.

Terms

Pen—any writing implement that may or may not include the ability to store ink. In some examples a stylus with no ink capability may be used as a pen in accordance with embodiments of the present invention.

Imaging System/Camera System—an Image Capture System.

Active Coding—incorporation of codes within the object or surface over which the input device is positioned for the purpose of determining positioning and/or movement of the input device using appropriate processing algorithms.

Passive Coding—detecting movement/positioning of the input device using image data, other than codes incorporated for that purpose, obtained from the object or surfaces over which the input device is moved using appropriate processing algorithms.

Input Device—a device for entering information which may be configured for generating and processing information, which may include, but is not limited to, a digital pen.

Active Input Device—an input device that actively measures signals and generates data indicative of positioning and/or movement of the input device using sensors incorporated within the input device.

Passive Input Device—an input device for which movement is detected using sensors incorporated other than within the input device.

Computing Device—a desktop computer, a laptop computer, Tablet PC™, a personal data assistant, a telephone, or any device which is configured to process information including an input device.

Example Computing Environment

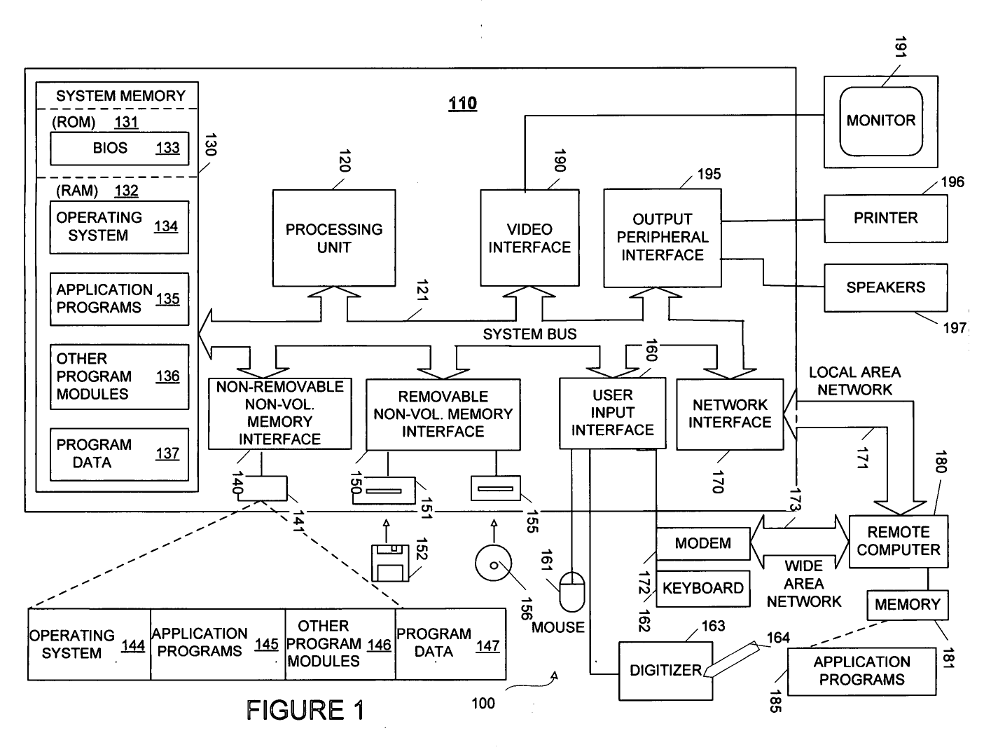

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing system environment 100 be interpreted as having any dependency or requirement relating to any one or combination of components illustrated in the exemplary computing system environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general-purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as ROM 131 and RAM 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disc drive 155 that reads from or writes to a removable, nonvolatile optical disc 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disc drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a digital camera (not shown), a keyboard 162, and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus 121, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

In one embodiment, a pen digitizer 163 and accompanying pen or stylus 164 are provided in order to digitally capture freehand input. Although a direct connection between the pen digitizer 163 and the user input interface 160 is shown, in practice, the pen digitizer 163 may be coupled to the processing unit 120 directly, via a parallel port or other interface and the system bus 121 as known in the art. Furthermore, although the digitizer 163 is shown apart from the monitor 191, the usable input area of the digitizer 163 may be co-extensive with the display area of the monitor 191. Further still, the digitizer 163 may be integrated in the monitor 191, or may exist as a separate device overlaying or otherwise appended to the monitor 191.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1A include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1A illustrates remote application programs 185 as residing on memory device 181. It will be appreciated that the network connections shown are exemplary and other means of establishing a communications link between the computers may be used.

It will be appreciated that the network connections shown are exemplary and other means of establishing a communications link between the computers can be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Example Input Device Configurations

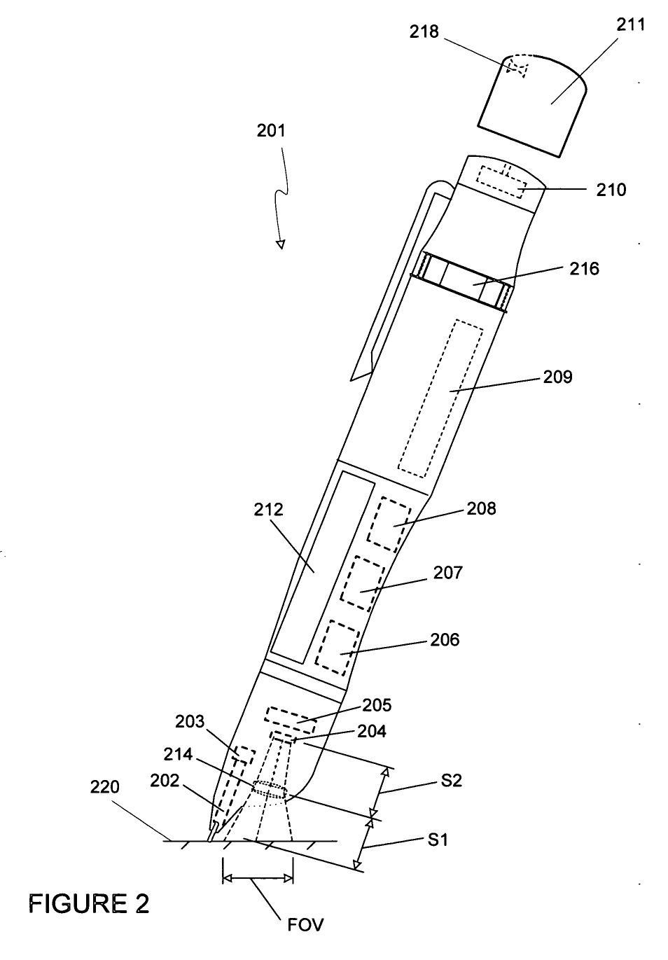

FIG. 2 provides an illustrative embodiment of an input device for use in accordance with various aspects of the invention. The following describes a number of different elements and/or sensors of input device embodiments. Various sensor combinations may be used to practice aspects of the present invention. Further, additional sensors may be included as well, including a magnetic sensor, an accelerometer, a gyroscope, a microphone, or any sensor for that might detect the position of the input device relative to a surface or object or provide additional functionality.

In FIG. 2, pen 201 includes an ink cartridge 202, a pressure sensor 203, an image sensor 204, an inductive element 205, a processor 206, memory 207, transceiver 208, power supply 209, docking interface 210, cap 211, display 212, lens 214, speaker 216 and adaptor lens(es) 218. The various components may be electrically coupled as necessary using, for example, a bus (not shown). Pen 201 may serve as an input device for a range of devices including a desktop computer, a laptop computer, Tablet PC™, a personal data assistant, a telephone, or any device which may process and/or display information. Further, pen 201 may also provide functionality as a stand alone device.

The input device 201 may include an ink cartridge 202 for performing standard pen and paper writing or drawing. Moreover, the user can generate electronic ink with the input device while operating the device in the manner typical of a pen. Thus, the ink cartridge 202 may provide a comfortable, familiar medium for generating handwritten strokes on paper while movement of the pen is recorded and used to generate electronic ink. Ink cartridge 202 may be moved into a writing position from a withdrawn position using any of a number of known techniques. Alternatively, ink cartridge 202 may be replaced with a cartridge that does not contain ink, such as a plastic cartridge with a rounded tip, but that will allow the user to move the pen about a surface without damaging the pen or the surface. Additionally, an inductive element or elements may be included to aid in detecting relative movement of the input device by, for example, providing signals indicative of the input device in a manner similar to those generated by a stylus. Pressure sensor 203 may be included for designating an input, such as might be indicated when the pen 201 is depressed while positioned over an object, thereby facilitating the selection of an object or indication as might be achieved by selecting the input of a mouse button, for example. Alternatively, the pressure sensor 203 may detect the depressive force with which the user makes strokes with the pen for use in varying the width of the electronic ink generated. Further, sensor 203 may trigger operation of a camera system that includes image sensor 204. In alternative modes, image sensor 204 may operate independent of the setting of pressure sensor 203.

Moreover, in addition to the pressure sensor which may act as a switch, additional switches may also be included to affect various settings for controlling operation of the input device. For example, one or more switches may be provided on the outside of the input device and used to power on the input device, to activate the camera system and/or a light source, and/or to control the sensitivity of the sensor or the brightness of the light source. Further, such switches may be provided to set the input device in a sketch mode in which conversion to text is not performed, to set the device to store the input data internally, to process and store the input data, to transmit the data to the processing unit such as a computing device with which the input device is capable of communicating, to switch modes of the device and/or to control any setting that might be desired.

Image sensor 204 may be included as part of a camera system to capture images of the surface over which the pen is moved. Inductive element 205 also may be included to enhance performance of the pen when used as a stylus in an inductive system. Processor 206 may be comprised of any known processor for performing functions associated with various aspects of the invention, as will described in more detail to follow. Similarly, memory 207 may include a RAM, a ROM, or any memory device for storing data and/or software for controlling the device or processing data. The input device may further include a transceiver 208. The transceiver permits information exchange with other devices. For example, Bluetooth® or other wireless technologies may be used to facilitate communications. The other devices may include a computing device which may further include input devices.

Power supply 209 may be included, and may provide power if the pen 201 is to be used independent of and remotely from the host device. The power supply 209 may be incorporated into the input device 201 in any number of locations, and may be positioned for immediate replacement, should the power supply be replaceable, or to facilitate its recharging should the power supply be rechargeable. Alternatively, the pen may be coupled to alternate power supplies, such as an adapter for electrically coupling the pen 201 to a car battery, a recharger connected to a wall outlet, to the power supply of a computer, or to any other power supply.

Docking interface 210 may be used to transfer information between the input device and a second device, such as an external host computer. The docking interface 210 may also include structure for recharging the power supply 209 when attached to a docking station (not shown) or when connected to a power supply. A USB or other connection may removably connect the input device to a host computer through the docking station, or through an alternative port. Alternatively, a hardwire connection may also be used to connect the pen to a second device capable of transferring and receiving data. In a hardwired configuration, the docking station link would be omitted in favor of wiring the input device directly to a host. The docking station may be omitted or replaced with another system for communicating with a second device (Bluetooth® 802.11b, for example).

The input device 201 may further include a removable cap 211. A variety of removable caps may be provided for input device 201, which can provide or enhance functionality of the input device. For example, removable cap 211 may provide one or more lenses 218, which, when the cap covers the writing end of the device, can change the focal length of the camera system that includes lens 214 and sensor 204. In another example, removable cap 211 may be equipped with a metal tip (not shown) for facilitating resistive sensing, so that input device 201 may be used with a device that includes a sensing board or touch screen, for example. In addition, cap 211 may include features that engage corresponding features of the input device when the cap is installed over the writing end to permit the input device to sense the installation state of the cap and, in a multiple cap configuration, to identify the type of cap installed thereon. For instance, the cap may include electrical contacts that interface with corresponding contacts on a portion of the input device, or cap may include geometric features that engage a detente switch or other feature of the input device. As an example, the input device may switch from a handwriting mode to an image capture mode when the cap is placed on the writing end.

The shell of input device 201 may be comprised of plastic, metal, a resin, a combination thereof, or any material that may provide protection to the components or the overall structure of the input device. The shell may include a metal compartment for electrically shielding some or all of the sensitive electronic components of the device. The input device may be of an elongated shape, which may correspond to the shape of a pen. The device may, however, be formed in any number of shapes consistent with its use as an input device and/or ink generating device.

Display 209 may include a liquid crystal display or other type of display that permits the user to review documents and images created. The user may select formatting of the document before or after the information, such as text, is input, or may review the document and make changes to the format of the document. Viewing the document created on such a display, in the context of the above example, the user may insert a header including his or her address in the appropriate location. In addition, as discussed further below, display 209 may show images captured by the device in a scene capture mode.

Sensor 204 may include a complementary metal oxide semiconductor (CMOS) image sensor, a charge-coupled device (CCD) image sensor, or other type of sensor for receiving image information. The camera system including sensor 204, lens 214 and processing component 206 permits pen 201 to generate electronic ink by detecting movement of the pen with respect to a writing surface. The camera system can capture images of the surface over which the pen is moved, and through image analysis, detect the amount of movement of the pen over the surface being scanned. The movements may be correlated with the document and electronically transpose, add, or associate (e.g. store input annotations apart from the original document) electronic ink to the document.

As an example for the configuration shown in FIG. 2, sensor 204 could be a CMOS or CCD image sensor array having a size of 128×100, 128×128, or larger, which may be appropriate for digital writing. Sensor 204 receives light through a lens system 214, which is focused on a Field of View (FOV) on the digital paper 220. Lens system 214 has an image distance S2 and an object distance S1 for recognizing patterns on paper 220 within the field of view. In one configuration, Image distance S2 is about 16 mm to 24 mm and is preferably 20 mm. Similarly, an object distance S1 is about 16 mm to 24 mm and is preferably about 20 mm. The field of view in such a configuration may be about 4 square millimeters (2 mm×2 mm) to about 36 square millimeters (6 mm×6 mm), and is preferably about 9 square millimeters to 25 square millimeters. Such a configuration of object and image distances provides a compact design for pen 201 that can effectively perform a variety of digital writing and scene capture functions.

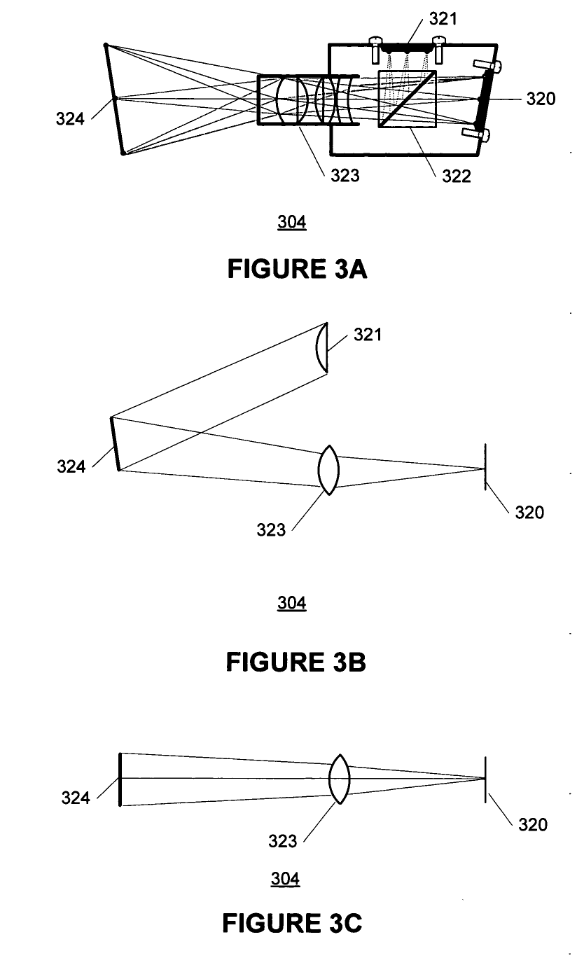

FIGS. 3A-3C show three additional illustrative embodiments of a camera system 304 for use in accordance with aspects of the present invention. As another example configuration, camera system 304 of FIG. 3A may be comprised of a light source 321 and a CMOS image sensor with the capability of scanning a 1.79 mm by 1.79 mm square area at a resolution of 32 pixels by 32 pixels. The minimum exposure frame rate for one such image sensor may be approximately 330 Hz, while the illustrative image sensor may operate at a processing rate of 110 Hz. The image sensor selected may comprise a color image sensor, a grayscale image sensor, or may operate to detect intensities exceeding a single threshold. However, selection of the camera system or its component parts may vary based on the desired operating parameters associated with the camera system, based on such considerations as performance, costs or other considerations, as may be dictated by such factors as the resolution required to accurately calculate the location of the input device.

Light source 321 may illuminate the surface over which the input device is moved. The light source may, for example, be comprised of a single light emitting diode (LED), an LED array, or other light emitting devices. The light source may produce light of a single color, including white, or may produce multiple colors. A half mirror 322 may be included within the camera system to direct light as desired. The camera system 304 may further include one or more optical devices 323 for focusing light from the light source 321 onto the surface scanned 324 and/or to focus the light reflected from that surface to the image sensor 320. The effect of illumination on image quality is often underestimated in optical system design. Proper illumination can increase the image contrast and resolution, thus improving the overall performance of the system in the writing mode as well as in a scene capture mode discussed below. As noted above, a light source may be comprised of a single light emitting diode (LED), an LED array, or other light emitting devices. The light source may produce light of white, single color or multiple colors. The illumination component may further include one or two optical devices for focusing light from the light source onto a surface and making the illumination profile as homogeneous as possible.

As illustrated in FIG. 3A, light emitted from light source 321 is reflected by half-mirror 322, a mirror that reflects or transmits light depending on direction of the impinging light. The reflected light is then directed through lens system 323 and transmitted to the reflective surface below. The light is then reflected off of that surface, through lens system 323, strikes half-mirror 322 at a transmission angle passing through the mirror, and impinges on sensing array 320. Of course, camera systems including a wide range of components may be used to capture the image data, including camera systems incorporating a lesser, or a greater, number of components. Variations in the arrangement of components may also be numerous. To provide just one example, in simplified arrangement, the light source and the sensing array may be positioned together such that they both face the surface from which the image is to be captured. In that case, because no reflections within the camera system are required, the half-mirror may be removed from the system. As shown in FIG. 3B, in a simplified configuration the light source 321 is positioned a distance from the lens 323 and sensor 320. In further simplified arrangement, as shown in FIG. 3C, the light source may be removed and ambient light reflecting off the object surface is focused by lens 323 onto the sensor 320.

Thus, variations in the components incorporated into the camera system, or their placement, may be employed in a manner consistent with aspects of the present invention. For example, the placement and/or orientation of the camera system and/or ink cartridge may be varied from that shown in FIG. 2 to allow for the use of a wide range of camera system and/or ink configurations and orientations. For example, camera system 304 in FIG. 3, or any of its component parts, may be located in openings adjacent those provided for the ink cartridge, rather than within the same opening as illustrated. As an additional example, camera system 304 may be positioned in the center of the input device with the ink cartridge positioned to the side of the camera system. Similarly, the light source 321 may be incorporated within the structure housing the remaining components of the camera system, or one or more components may be positioned separate from the others. Furthermore, a light projecting feature may also be enabled, using a light source and/or optical system, with additional structure and/or software, or modifications to the illustrated components as necessary.

To aid in the detection and/or positioning of the input device, the surface of an object over which the input device is positioned may include image data that indicates the relative position of areas of the surface. In one exemplary embodiment, the surface being scanned may comprise the display of a host computer or other external computing device, which may correspond to the monitor of a desktop computer, a laptop computer, Tablet PC™, a personal data assistant, a telephone, digital camera, or any device which may display information. Accordingly, a blank document or other image generated on the screen of a Tablet PC™ may include data corresponding to a code that represents the relative position of that portion of the document within the entire document, or relative to any other portion of the image. The information may be comprised of images, which may include alphanumeric characters, a coding pattern, or any discernable pattern of image data that may be used to indicate relative position. The image or images selected for use in designating the location of areas within the surface of the object may depend on the sensitivities of the scanning device incorporated into the camera system, such as the pixel resolution of the sensor, and/or the pixel resolution of the image data contained within the surface being scanned. The location information extracted from the object may then be used to track movement of the input device over the object. Using that information, electronic ink or other information corresponding to movement of the input device may be accurately generated. Location information may be used to both detect the position within the image at which the input is to be affected, as well as to provide an indication of movement of the input device over the object surface. The resulting information may be used interactively with word processing software to generate changes in a document, for example.

In an alternate embodiment, the object used in combination with the input device may be composed of paper with positional information included in the background, for example. The positional information may be incorporated in any form of code, optical representation, or other form that may be sensed by a sensor associated with the input device and used to represent the relative location of the specific site on the paper.

Further, the surface over which the input device is moved may include the display of a computing device, a mouse pad, a desktop, or any non-uniform reflective surface from which objects or image data may be extracted indicating movement of the input device over that surface. The tracking algorithm with which the captured image data may be processed may be fixed or may vary dependent on the characteristics of the images captured. Using a simple tracking algorithm, the processor may detect grains in the wood of a desktop, for example, and based on a comparison of a sequence of images captured by the camera system, the relative location of particular patterns of grain within successive images may be used to determine the location of the input at various times and/or the relative movement of the input device over that surface. A more complex tracking algorithm may be required where features within the images are less easily discerned and the image more uniform. Alternative passive coding techniques, including, but not limited to, the coding techniques found in U.S. Ser. No. patent application 10/284,451 filed Oct. 31, 2002, entitled, “Passive Embedded Interaction Code,” the contents of which are herein incorporated by reference, may also be employed consist with aspects of the invention.

Operational Examples of Input Device Configurations having a Scene Capture Mode

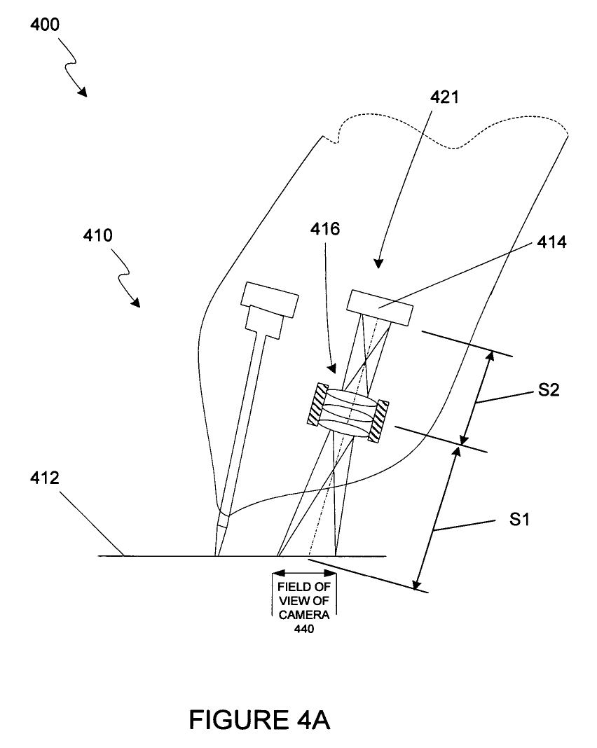

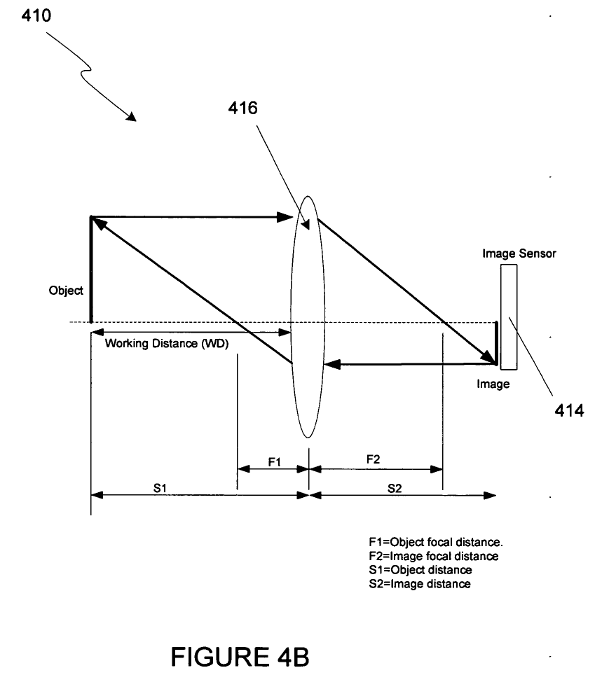

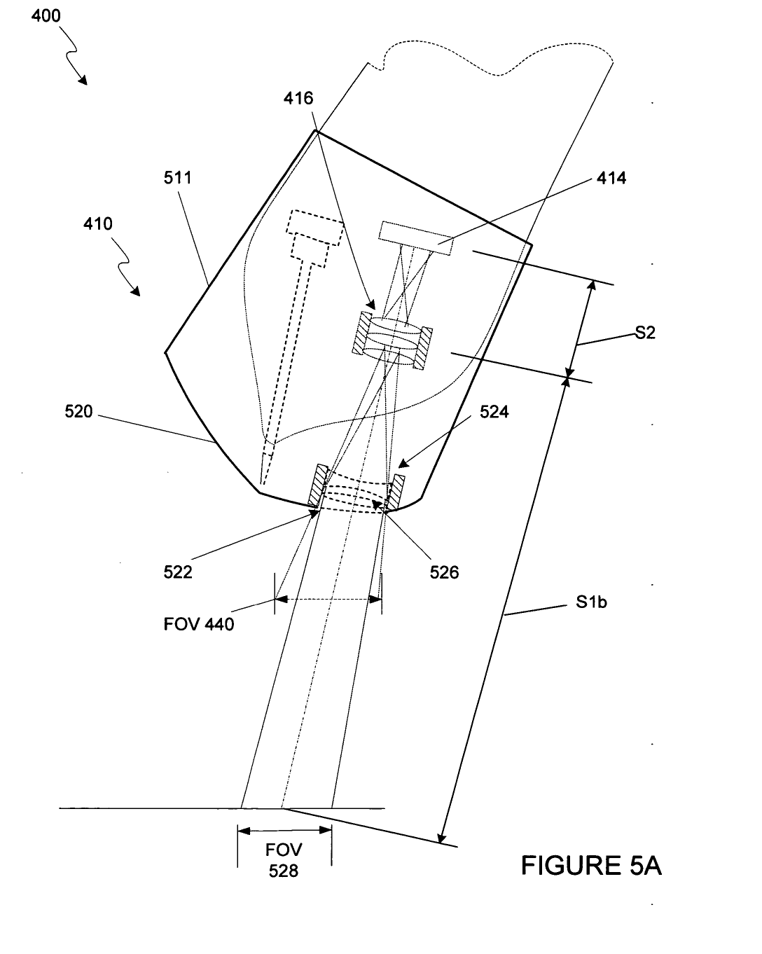

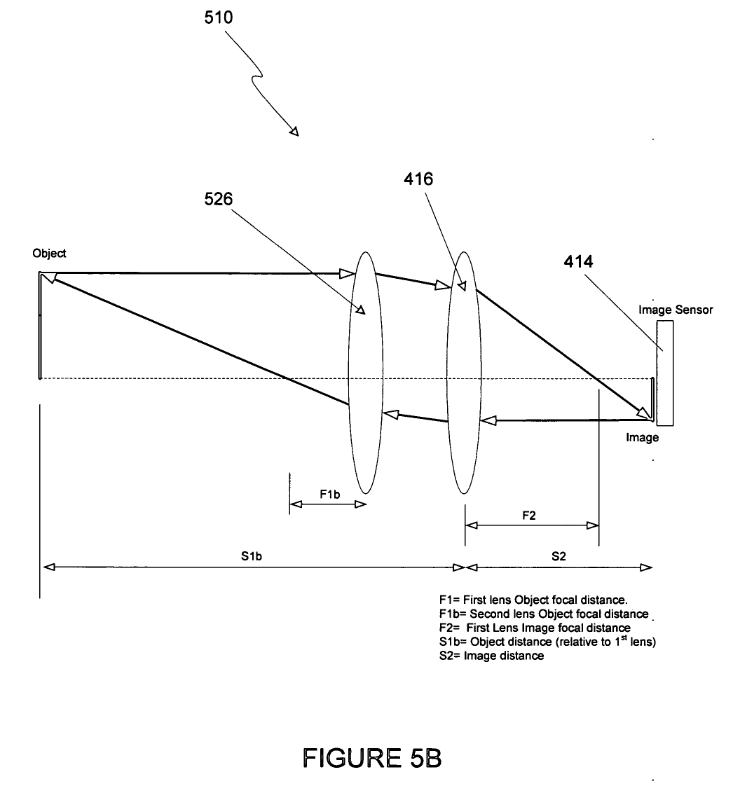

Referring now to FIGS. 4A-5B, an embodiment of an imaging system 410 of an input device 400 is shown while in a writing mode (FIGS. 4A and 4B) and while in a scene capture mode (FIGS. 5A and 5B). Input device 400 generally includes aspects and features of input device 201 discussed previously. As shown, input device 400 is configured as a digital pen that cooperates with a writing surface 412 to generate digital ink. Imaging system 410 includes an imaging sensor 414, such as a 128×128 pixel CMOS imaging sensor, and a lens or set of lenses 416. The set of lenses are configured to provide focused lights rays reflected from writing surface 412 to the imaging sensor that fall within a field of the camera system's view 440. Collectively, the set of lenses have an object focal length F1 (see FIG. 4B), which is the distance from the front focal point to the set of lenses 416. The set of lenses also have an image focal distance F2 over which they transmit to the sensor focused images that fall within the camera system's field of view 418 (see FIG. 4A) at its object distance S1 from the set of lenses 416. The image distance S2 is generally the distance from the set of lenses to the image sensor. In one configuration, the object distance S1 may be 20 mm±4 mm, the image distance S2 may be about 15 mm, and the field of camera system's view 418 may be a 5 mm×5 mm area on writing surface 412. As such, while pen 400 is in a writing mode, imaging system 410 generally acts as a conventional camera that is focused and configured for taking pictures of very close objects (i.e., objects about 20 mm from the set of lenses) that fall within its field of view, such as images on writing surface 412.

FIGS. 5A and 5B show input device 400 while in a scene capture mode in which adaptor 511 is installed over the tip portion of the pen. Adaptor 511 can provide a quick and effective mechanism for changing the mode of the input device and for changing the configuration of the imaging system 410 from a close picture-taking configuration to a distance picture-taking configuration. In other words, the adaptor facilitates changing the focal length of the camera system from an object focal distance F1 for recognizing handwriting movements at an object distance S1 of about 20 mm in the present example, to a second focal length for capturing scenes and other images at a greater object distance S1b, such as about 100 mm.

Scenes as used herein generally refer to images that capture a portion of a visual precept, such as a portion of a picture generally captured via conventional camera systems. However, scenes may also include larger images, depending on the capabilities of the image capture system and the input device. As noted below, stitching software may be provided in the input device and/or in a host computer to stitch a plurality of scenes into a large image. Scenes or other images beyond the object distance S1 used in the handwriting mode are captured via the use of adaptor 511, which acts as a focal length adaptor for the imaging system and may also act as a cap for the pen.

Adaptor 511 includes a housing 520, an input aperture 522, an exit aperture 524, and one or more adaptor lenses 526. Housing 520 mates with the pen at an input region for the camera system and provides a support structure for apertures 522 and 524 and adaptor lenses 526. The housing may be made from a relatively rigid material, such as a plastic (e.g., polypropylene). The input aperture 522 is directed toward a new field of view 528 for the camera system, which may be in a different direction than the field of view 440 for the writing mode illustrated in FIGS. 4A and 4B. For instance, adaptor 511 and input aperture 522 may include channels and arrangements of mirrors (not shown) to permit the camera system to receive light from numerous fields of view. In the example configuration of FIGS. 5A and 5B, input aperture 522 is generally aligned with the field of view 440 for the pen during its writing mode. Thus, its field of view 528 is located in front of the writing end of the pen 400. However, it could be oriented rearward or in various other directions. Further, it may utilize other focal distances.

Adaptor lenses 526 include one or more lens that collectively cooperate with set of lens 416 to increase the focal length of camera system 414, and to provide a second focal length to camera system 414 as its overall focal length. This second focal length is preferably close to infinity for taking scene snapshots, although other focal lengths may be desired depending upon the distance from the pen to the object scene. As shown in FIGS. 5A and 5B, light rays received at input aperture 522 can converge at imaging system 410 as they pass though adaptor lenses 526 and set of lenses 416.

A wide variety of adaptors can be provided according to the invention that will modify imaging system 410 to permit it to capture focused images at various distances S1b (see FIGS. 5A and 5B) than the object distance S1 (see FIGS. 4A and 4B) of its native, writing mode. For instance, a user may select an adaptor that has a desired focal length depending upon the distances and types of images to be captured in the scene capture mode. In some instances a wider viewing area may be desirable and in other instances a narrower, magnified viewing area may be desirable, such as a zoomed or telephoto view.

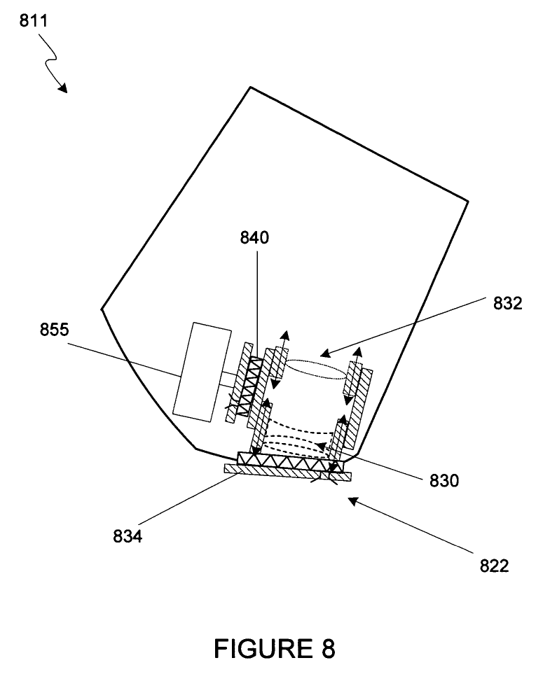

FIG. 8 shows another adaptor 811 according to an embodiment of the invention that has adjustable focal lengths similar to conventional photographic camera lens systems. As shown, adaptor 811 includes a first lens or set of lenses 830 and a second lens or set of lenses 832. The second set of lenses 832 are slidably mounted with respect to first set of lenses 830. The distance between the lenses 830 and 832 may be adjusted via a thumbwheel 840 extending through a wall of the adaptor and/or an adjustment ring 834 disposed at the input aperture 822, which permit the user to select a desired focal length for the adaptor. In other configurations, either or both of the first and second sets of lenses may be movable into various preset configurations that correspond to certain focal lengths. The lenses may be manually movable to a desired focal length or a preset focal length via the thumbwheel and/or adjustment ring. In alternate configurations, a small motor 855 in the input device could control the adjustable lens configurations.

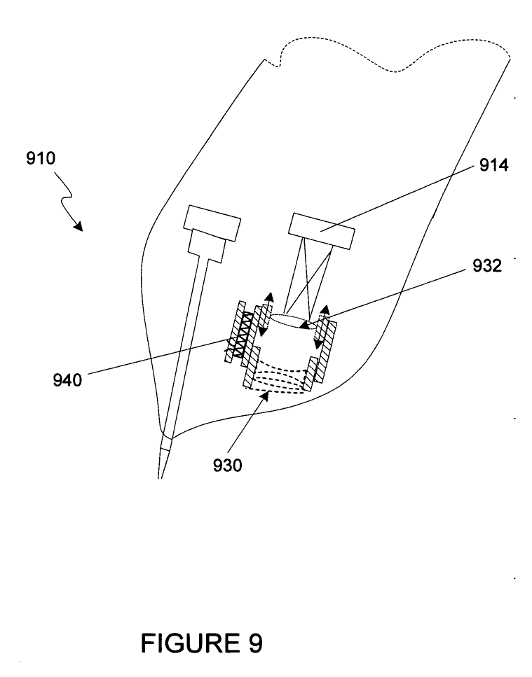

FIG. 9 shows an imaging system 910 according to another embodiment of the invention that has focal length adjustability built into the input device 900. As such, the focal length of camera system 914 may be modified on the input device itself without the need for an adaptor. Imaging system 910 includes a first lens or set of lenses 930 and a second lens or set of lenses 932. As with adaptor 811 of FIG. 8, the second set of lenses 932 are slidably mounted with respect to first set of lenses 930. The distance between the lenses 930 and 932 may be adjusted via thumbwheel 940, which permits the user to select a desired focal length between a writing mode and a scene adaptor mode, as well as to permit multiple options for the scene adaptor mode. In an alternate configuration, a small motor (not shown) in the input device could control the adjustable configuration of the lens.

Input devices according to aspects of the invention can provide various benefits. For instance, an input device for which the focal length of its camera system can be changed permits the device to be multi-functional. Such a device can provide the digital ink and writing benefits of a digital pen while in the writing mode. In addition, such a device can permit the user to captures scenes similar to photographic images or video clips. This can be particularly beneficial for taking pictures related to writing functions, such as for capturing the image of a portion of paper the user is tracing with the input device or for capturing the image of a business card of a person the user encounters at a business meeting. Although relatively small-resolution camera systems are discussed with the present examples, larger resolution image devices may also be used that permit the user to take higher resolution photographs or videos. In addition, stitching software may be provided with the input device and/or a related computing device that permits multiple small images to be stitched together into a larger image.

Futhermore, the input device of the present invention can also be used for remote storage and transfer of data at a later time. Thus, the input device of the present invention can be used without a host PC nearby. The processing power and storage capabilities of the input device can process images captured by the image sensor and store them for transmission at a later time. For example, when a user uses the input device to capture image scenes, take notes and/or annotate a document, the images, notes and/or annotations can be processed and stored in the input device indefinitely. Alternatively, the data can be transferred to a personal digital assistant (PDA) immediately and/or at a later time and processed and stored on the PDA. If the PDA has wireless communication capabilities, the data can be transferred to a host PC or a server at a remote location.

For example, when users travel, the notes, annotations and scenes capture with the input device can be transferred back to their host PC via their phone. A user can make annotations to a document while on a plane and save the annotations for transmittal to a host PC and/or server at a later time, such as when the plane has landed. In addition, the input device can be used as a pass-through device that provides extended functionality to a host computer. For instance, an input device in communication with a host computer via a wireless or a wired connection may be used as a camera, a video capture device, a scanner, and etc. while in the scene capture mode (e.g., for larger views) or in the writing mode (e.g., for close images).

As noted above, the input device may include a suitable display, such as display 212 in FIG. 2, which can permit the user to review images captured by the device and to interact with the device to manage the images. Alternatively, the display of a host computing device may be used to review documents and images created. The user may select formatting of the document before or after the information, such as text, is input, or may review the document and make changes to the format of the document. Viewing the document created on such a display, in the context of the above example, the user may insert a header including his or her address in the appropriate location.

Example Input Device Hardware Configurations

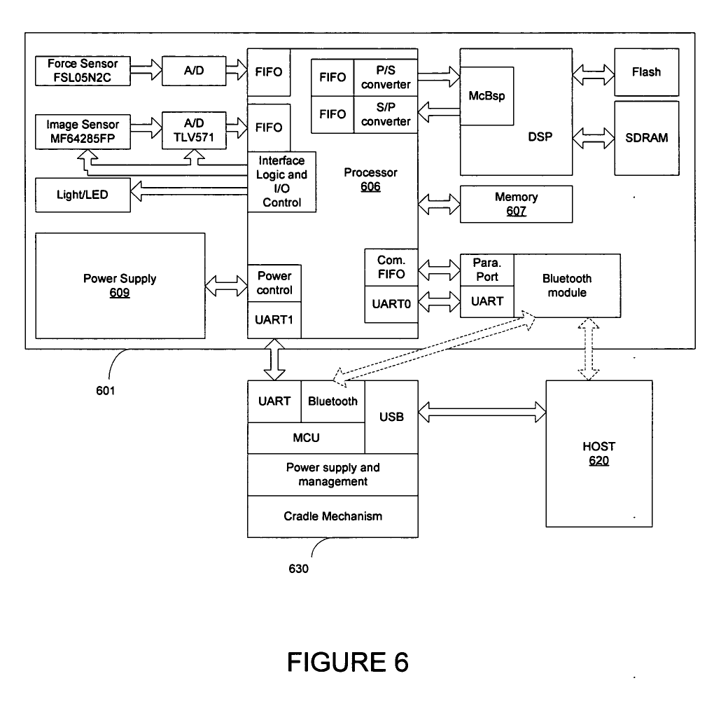

FIG. 6 shows a hardware architecture of a system in accordance with one embodiment of the present invention. Many of the same or related components illustrated in previous embodiments will be represented using like reference numerals. Processor 606 may be comprised of any known processor for performing functions associated with various aspects of the invention. For example, the processor may include an FPSLIC AT94S40, and may be comprised of an FPGA (Field Programmable Gate Array) with an AVR core. That particular device may include a 20 MHz clock and operate at a speed of 20 MIPS. Of course, selection of a processor for use in input device 601 may be dictated by the cost and/or processing speed requirements of the system. The processor 606 may perform image analysis, should such analysis be conducted within the input device. Alternatively, processing may be performed by a second processor, such as a digital signal processor (DSP) incorporated into the device 601. The processor 606 may further operate to perform steps critical to reducing power consumption to conserve power stored in power supply 609, such as powering down various components when the input device is inactive, which may be based on data indicating movement and/or positioning of the device. The processor 606 may further operate to calibrate and regulate the performance of various components, including adjustments to the intensity of light source or to the sensitivity of the sensing array of camera system, for example. Also, the processor, or a coupled digital signal processor, may choose from among a plurality of stored image processing algorithms, and may be controlled to select the image analysis algorithm most suitable for detecting movement, in accordance for example, characteristics associated with the surface over which the device is moved. Thus, the image processing algorithm may be selected automatically based on performance considerations programmed into the input device. Alternatively, the input device may be controlled, and settings established, based on inputs selected by a user, for example, via actuations of the force sensor or inputs on the input device, or based on handwritten strokes corresponding to commands.

In one embodiment, memory 607 may include one or more RAMs, ROMs, FLASH memories, or any memory device or devices for storing data, storing software for controlling the device, or for storing software for processing data. As noted, data representing location information may be processed within the input device 601 and stored in memory 607 for transfer to a host computer 620. Alternatively, the captured image data may be buffered in memory 607 within the input device 601 for transfer to a host device 620 for processing or otherwise.

Transceiver, or communication unit, may include a transmission unit and receiving unit. As noted, information representing movement of the input device, either processed into a form suitable for generating and/or displaying electronic ink or otherwise, may be transmitted to a host computer 620, such as the previously described desktop computer, laptop computer, Tablet PC™, personal digital assistant, telephone, or other such device for which user inputs and electronic ink might be useful. The transceiver may communicate with an external device using any wireless communication technique, including Bluetooth® technology, for performing short-range wireless communications, infrared communications, or even cellular or other long range wireless technologies. Alternatively, the transceiver may control the transmission of data over a direct link to a host computer, such as over a USB connection, or indirectly through a connection with docking cradle 630. The input device may also be hardwired to a particular host computer using a dedicated connection. The transceiver may also be used to receive information and/or software, which in one embodiment, may be used for improving performance of the input device. For example, program information for updating the control functions of the processor may be uploaded via any of the previously described techniques. Moreover, software may also be transmitted to the input device, including software for analyzing the image data and/or for calibrating the input device may be downloaded from an external device.

Processor 606 may operate in accordance with an interaction model. An interaction model may be implemented in the form of software for maintaining a consistent experience in which electronic ink is generated regardless of the external device for which the unit performs the functions of an input device. The interaction model may process captured data for conversion into a form universally suitable for use on any number of host devices including a desktop computer, a laptop computer, Tablet PC™, a personal data assistant, a telephone, a whiteboard, or any device that might store, display or record data input via the input device. The processor 606 may recognize the device to which it is connected, or for which the data representing handwritten inputs are intended, and based on such recognition, select processing that converts input data into a form suitable for the specific host device recognized. In that case, a conversion to a form useful for each potential recipient computing device would be contained within the input device and made available as necessary. Recognition of the intended recipient device may be attained as a result of communication between the devices, should they be connected wirelessly or directly. Alternatively, the user may enter the identity of the device or devices for which the data is intended directly into the input device. Of course, if the input device includes a display, data may be processed using a default processing algorithm suitable for use with the display and/or a multitude of other devices.

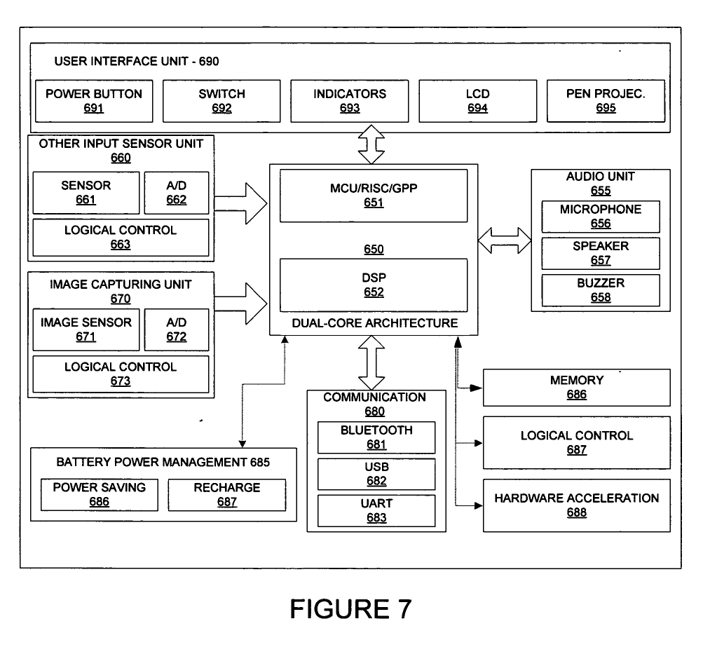

FIG. 7 shows another hardware architecture of a system in accordance with at least one aspect of the present invention. The hardware architecture may be a suite of printed circuit board assemblies (PCAs) and firmware running on the PCAs. The components of the suite of PCAs include a dual core architecture component 650, an image capturing unit 670, another input sensor unit 660, a communication component 680, an audio unit 655, a user interface unit 690, memory 686, logical control 687, and a hardware acceleration component 688. It should be understood by one skilled in the art that the following boards and their description are not all necessary for the present invention and one or more components may be included for operation of the present invention.

The dual core architecture component 650 includes a RISC (Reduced Instruction Set Computer) or GPP (General Purpose Processor) 651 used for running an embedded OS (Operating System), such as Windows CE®. DSP (Digital Signal Processor) 652 is in charge of running algorithms, such as image processing, maze pattern analysis and m-array decoding. The two cores may be two different chips or built into one chip. MCU/RISC/GPP component 651 may have several sensors and A/D (analog to digital conversion) chips operating simultaneously. The sensors and A/D chips need to be configured and controlled at the same time. MCU/RISC/GPP component 651 can handle system control, computation, and communication because MCU/RISC/GPP component 651 is suitable for real-time parallel computing. One example of MCU/RISC/GPP component 651 may include three chips: XCV50CS144, an FPGA chip from Xilinx of San Jose, Calif. with 50 K logic gates and 96 user IOs; XC18V01, a configuration PROM from Xilinx of San Jose, Calif.; and CY62256V, a 32KX8 SRAM (static RAM) from CYPRESS of San Jose, Calif., as buffer for computation.

DSP (Digital Signal Processor) component 652 may consist of two chips. The TMS320VC5510 is a high-performance, low power-consumption, fixed-point DSP chip from Texas Instruments (TI) of Dallas, Tex. Such a chip is very suitable for mobile computing devices. This chip is used for computation to recover strokes as written by the user. The second ship of the DSP component 652 may be the SST39LF160, a 16M bit multi-purpose flash memory from SST of Sunnyvale, Calif. This non-volatile, reliable, compact storage chip is used to store DSP firmware and computation result.

Two input units include the other input sensor unit 660, which may be a force sensor, and the image capturing unit 670. These units generate force and image signals that are outputted to the dual architecture component 650 respectively. Other input sensor unit 660 may include a FSL05N2C, a force sensor chip 661 from Honeywell of Morristown, N.J., a MAX4194, instrumentation amplifier 663 from MAXIM of Sunnyvale, Calif., and a MAX1240, a 12-bit serial A/D converter 662 from MAXIM of Sunnyvale, Calif. Other input sensor unit 660 is configured to sense subtle force changes, in 12-bit precision, at up to about 100K samples per second. Precise force data is needed to indicate whether the input device is being used for writing or how hard the user is pushing the input device while writing. Image capturing unit 670 may include a MF64285FP, a 32×32-pixel image sensor chip 671 from Mitsubishi of Tokyo, Japan, a TLV571, an 8-bit A/D converter 672 from TI of Dallas, Tex., and a logical control component 673. Image capturing unit 670 can capture images at up to 336 fps (frame per second). A minimum 32*32-pixel resolution image sensor is chosen, because a lower resolution cannot capture enough features for processing. Image sensor 671 is a high speed, small sized, low power-consumption image sensor. Image capturing unit 670 may include additional sensors for capturing image data from multiple areas. For example, an input device employing two image sensors 671 may be used for operation with a whiteboard. One image sensor 671 can be configured to capture data representative of the writing of a user. A second image sensor 671 may be configured to scan an indicator, such as a bar code, of a whiteboard pen. In such an example, the bar code of the whiteboard pen may include information pertaining to the color and/or thickness of the whiteboard pen. The second image sensor 671 can capture this data to identify that a user is using a blue whiteboard pen and has a thickness of 1.5 cm.

Communications component 680 may include a WML-C09 chip 681 and an antenna. WML-C09 chip 681 is a Class 2 Bluetooth® module from MITSUMI of Tokyo, Japan. The Bluetooth® chip enables an input device to communicate with a host PC at a speed of 720K bps (bits per second) or 100 frames per second within a range of 10 meters. Bluetooth® is a low cost, low power cable replacement solution with industry wide support, which is suitable for use with the present invention. Each Bluetooth® module is assigned a specific and/or unique Bluetooth® address which can be used to identify the input device itself. Communication component 680 may include a USB port 682 and a UART component 683.

Battery power management component 685 is designed to generate all necessary voltages, for example, 5V, 3.3V, 2.5V, 1.6V, from a supplying Li-ion battery. A 5V supply may be used by image sensor 671 and force sensor 661. A 2.5V supply may be used by the MCU/RISC/GPP component 651 for internal power. A 1.6V supply may be used by the DSP component 652 for internal power. A 3.3V supply may be used by other components, such as for the communication component 680. Power saving component 686 conserves the operational life of the battery power and recharge component 687 recharges the battery power of the input device. Over-discharge protection is also designed to prevent the battery from being damaged. Battery power management component may include the following chips: UCC3952PW-1 from TI of Dallas, Tex. and MAX9402SO8 from MAXIM of Sunnyvale, Calif., together to realize over-discharge protection; TPS60130PWP from TI of Dallas Tex., to generate a 5V supply output; TPS62006DGSR from TI of Dallas, Tex., to generate a 2.5V supply output;

TPS62000DGSR from TI of Dallas, Tex., to generate a 1.6V supply output; and

TPS62007DGSR from TI of Dallas, Tex. and/or TPS79333 from TI of Dallas, Tex., to generate a 3.3V supply output.

Audio unit 655 provides for audio interface components of the input device. Audio unit 655 may include a built-in audio player system, such as an MP3 player. Microphone 656 permits voice recording capabilities while using the input device. Speaker 657 can output audio from a variety of sources, including a built-in and/or external MP3 player, a multi-media file, an audio file, and or/some other audio source. Buzzer 658 may be an audible indicator for a user, such as an illegal operation indicator and/or low battery power indicator.

User interface unit 690 provides various user interface elements for communication to and from a user. Power button 691 permits a user to turn the input device on or off and can also be configured to enter into a sleep, standby, or low power mode for conservation of battery power. Functional button/switch 692 can be used as a command input to the input device. Functional button/switch may be an actuatable button for choosing an element in an application program with which the input device operates. Indicators 693 may be LEDs (light emitting diodes) and/or other optical outputs for visual communication with a user. Indicators 693 may change colors, intensity, and /or pulse rate. For example, indicator 693 may change colors when input device changes to a low power mode. LCD (liquid crystal display) 694 may be a mini display that outputs visual information to user. For example, LCD 694 may indicate that the battery is low on the user interface by showing “LO BAT” on the display. Pen projection 695 permits the projection of an image onto a surface. Pen projection 695 provides additional visual information to a user of the input device.

Memory 686 allows for storage of any type of information, including force sensor 661 and image sensor 671 data and operational instructions for a particular application program with which the user interface may operate. Logical control 687 may be used to control peripheral devices. Logical control 687 may be an FPGA or a CPLD (complex programmable logic device). Hardware acceleration unit 688 may be configured to accelerate algorithms in order to increase efficiency of computations of the input device.

Although the invention has been defined using the appended claims, these claims are illustrative in that the invention may be intended to include the elements and steps described herein in any combination or sub combination. Accordingly, there are any number of alternative combinations for defining the invention, which incorporate one or more elements from the specification, including the description, claims, and drawings, in various combinations or sub combinations. It will be apparent to those skilled in the relevant technology, in light of the present specification, that alternate combinations of aspects of the invention, either alone or in combination with one or more elements or steps defined herein, may be utilized as modifications or alterations of the invention or as part of the invention. It may be intended that the written description of the invention contained herein covers all such modifications and alterations. For instance, in various embodiments, a certain order to the data has been shown. However, any reordering of the data is encompassed by the present invention. Also, where certain units of properties such as size (e.g., in bytes or bits) are used, any other units are also envisioned.

We claim:

1. An input device for generating data representative of handwritten strokes and for capturing scenes, the input device comprising:
an image capturing unit for capturing handwriting image data representative of handwriting strokes based on movement of the input device and for capturing scene image data, the image capturing unit having a first focal length while in the handwriting mode and a second focal length while in a scene capture mode, the second focal length being different than the first focal length;
a processor for generating handwriting data based on the captured handwriting image data; and
a memory for storing the handwriting data and the scene image data.

2. The input device of claim 1, wherein the second focal length is larger than the first focal length.

3. The input device of claim 2, wherein the second focal length is a substantially infinite focal length.

4. The input device of claim 1, wherein the second focal length is smaller than the first focal length.

5. The input device of claim 1, further comprising an adaptor for changing the image capturing unit from the first focal length to the second focal length.

6. The input device of claim 5, wherein the input device includes a digital pen and the adaptor includes a pen cap.

7. The input device of claim 6, wherein the image capturing unit automatically changes from the handwriting mode to the scene capture mode in response to the pen cap being placed in a scene capture position.

8. The input device of claim 5, wherein one of the adaptor and the image capturing unit includes a focal length adjustment mechanism for changing the focal length of the image capturing unit.

9. The input device of claim 8, wherein the focal length adjustment mechanism is manually adjustable.

10. The input device of claim 8, wherein the focal length adjustment mechanism comprises a motor for powering the focal length adjustment mechanism.

11. The input device of claim 1, further comprising a communication unit for transmitting the handwriting data and the scene image data to an external processing unit.

12. The input device of claim 11, wherein the communication unit is configured to wirelessly transmit the handwriting data and the scene image data.

13. The input device of claim 10, wherein the external processing unit is configured to stitch a plurality of scenes into a stitched image.

14. The input device of claim 1, wherein the image capturing unit comprises a first image sensor for capturing the handwriting image data and a second image sensor for capturing the scene image data.

15. The input device of claim 1, wherein the processor is configured to stitch a plurality of scenes of the scene image data into a stitched image.

16. A method for capturing image data via a single input device, the method comprising:
placing the input device in a handwriting mode;
while in the handwriting mode, capturing first image data representative of handwritten strokes;
placing the input device in a scene capture mode;
while in the scene capture mode, capturing second image data including scenes.

17. The method of claim 16, wherein the step of capturing first image data representative of handwritten strokes includes capturing the first image data at a first focal length and the step of capturing second image data includes capturing the second image data at a second focal length that is different than the first focal length.

18. The method of claim 17, wherein the first focal length is greater than the second focal length.

19. The method of claim 16, further comprising switching between the handwriting mode and the scene capture mode in response to adding a focal length adaptor to the input device.

20. A digital pen for generating data representative of handwritten strokes and for capturing scenes, the digital pen comprising:
a camera system capturing an image of an area of an object over which the digital pen is positioned while in a handwriting mode and generating captured image data, the camera system having a first focal length while in the handwriting mode and a second focal length while in a scene capture mode, the second focal length being larger than the first focal length; and
a processor for processing the captured image data;
a memory for storing data representative of handwritten strokes based on first image data of the captured image data, the first image data including image data captured while in the handwriting mode, and for storing scenes captured while in the scene capture mode; and
a pen cap for changing the camera system from the first focal length to the second focal length.
